(19) United States
(12) Patent Application Publication
(10) Pub. No.: US 2006/0187221 A1
(43) Pub. Date: Aug. 24, 2006

(54) System and method for identifying and removing virtual objects for visualization and computer aided detection

(76) Inventors: Sarang Lakare, Malvern, PA (US); Luca Bogoni, Philadelphia, PA (US); Arun Krishnan, Exton, PA (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/358,480

(22) Filed: Feb. 21, 2006

Related U.S. Application Data
(60) Provisional application No. 60/664,393, filed on Mar. 23, 2005.
(60) Provisional application No. 60/655,008, filed on Feb. 22, 2005.

(51) Int. Cl. G06T 17/00

(52) U.S. Cl. 345/424

(57) ABSTRACT

A method for removing a virtual object from a digitized image comprises the steps of computing a point spread function of the intensities of an image, wherein a point spread function is a measure of the blurriness of said image, marking a plurality of points that represent an object of interest in the image, and subtracting the point spread function value from the intensity for each marked point, wherein the object of interest is removed from said image.

### CROSS REFERENCE TO RELATED UNITED STATES APPLICATION

This application claims priority from “Point Spread Function Filtering for De-Tagging”, U.S. Provisional Application No. 60/664,393 of Sarang Lakare, filed Mar. 23, 2005, the contents of which are incorporated herein by reference, and from “Virtual Object Removal for Visualization and Computer Aided Detection and Diagnosis”, U.S. Provisional Application No. 60/655,008 of Lakare, et al., filed Feb. 22, 2005, the contents of which are incorporated herein by reference.

### TECHNICAL FIELD

This invention is directed to the identification and removal of virtual objects from volumetric digital image data for visualization, image processing, and computer aided detection.

### DISCUSSION OF THE RELATED ART

The diagnostically superior information available from data acquired from current imaging systems enables the detection of potential problems at earlier and more treatable stages. Given the vast quantity of detailed data acquirable from imaging systems, various algorithms must be developed to efficiently and accurately process image data. With the aid of computers, advances in image processing are generally performed on digital or digitized images.

Digital images are created from an array of numerical values representing a property (such as a grey scale value or magnetic field strength) associable with an anatomical location points referenced by a particular array location. The set of anatomical location points comprises the domain of the image. In 2-D digital images, or slice sections, the discrete array locations are termed pixels. Three-dimensional digital images can be constructed from stacked slice sections through various construction techniques known in the art. The 3-D images are made up of discrete volume elements, also referred to as voxels, composed of pixels from the 2-D images. The pixel or voxel properties can be processed to ascertain various properties about the anatomy of a patient associated with such pixels or voxels. Computer-aided diagnosis (“CAD”) systems play a critical role in the analysis and visualization of digital imaging data.

The efficient visualization of volumetric datasets is important for many applications, including medical imaging, finite element analysis, mechanical simulations, etc. The 3-dimemsional datasets obtained from scanning modalities such as computed tomography (CT), magnetic resonance imaging (MRI), positron emission tomography (PET), ultrasound (US), etc., are usually quite complex, and contain many different objects and structures. In many instances, it is difficult to distinguish between two different objects that have similar intensity values in the imaged data. In other cases, the region of interest to the user is surrounded either partially or completely by other objects and structures. There is often a need to either remove an obstructing surrounding object, or to keep the region of interest and remove all other objects.

Visualization of an image can be accomplished by volume rendering the image, a set of techniques for displaying, three-dimensional volumetric data onto a two-dimensional display image. In many imaging modalities, resulting intensity values or ranges of values can be correlated with specific types of tissue, enabling one to discriminate, for example, bone, muscle, flesh, and fat tissue, nerve fibers, blood vessels, organ walls, etc., based on the intensity ranges within the image. The raw intensity values in the image can serve as input to a transfer function whose output is a transparency or opacity value that can characterize the type of tissue. A user can then generate a synthetic image from a viewing point by propagating rays from the viewing point to a point in the 2-D image to be generated and integrating the transparency or opacity values along the path until a threshold opacity is reached, at which point the propagation is terminated. The use of opacity values to classify tissue also enables a user to select which tissue is to be displayed and only integrate opacity values corresponding to the selected tissue. In this way, a user can generate synthetic images showing, for example, only blood vessels, only muscle, only bone, etc.

Three-dimensional volume editing is performed in medical imaging applications to provide for an unobstructed view of an object of interest, such as a fetus face. For example the view of the fetus face may be obstructed by the presence of the umbilical cord in front of the fetal head. Accordingly, the obstructing cord should be removed via editing techniques to provide an unobstructed image of the face. Existing commercial software packages perform the clipping either from one of three orthogonal two-dimensional (2D) image slices or directly from the rendered 3D image.

Tagging using a contrast agent is a commonly used technique for highlighting a particular object in imaged data. Tagging is often used to highlight an object of interest, and at times, is also used to highlight an object that is not desirable, but whose physical removal is either impossible or difficult and impractical. For example, tagging is often used in virtual colonoscopy to highlight residual material insider the colon. Physical removal of the residual material is impractical as that can cause significant discomfort for the patient being examined. Often, however, it is necessary to de-tag the images data, or, in other words, to remove the tagged object to enable the processing of the remaining data.

Prior techniques for object removal extract the object from the volumetric dataset such that the intensity values of the voxels belonging to the object are substituted with other values. These techniques modify the input volume in such as way as to be very undesirable, especially in the field of medical imaging.

An example of tagging is digital subtraction bowel cleansing, a technique that helps reduce the duress of the pre-examination bowel cleansing required for conventional computed tomographic (CT) colonography. With this technique, patients are asked to ingest small aliquots of positive contrast material starting approximately 2 days before examination. After a CT image acquisition, the opacified contrast enhanced colon contents are subtracted from the images by using specialized software, which in theory leaves native soft tissue elements of the bowel, such as polyps and folds, untouched. A radiologist then evaluates the modified images as a means of noninvasive screening for colon polyps.

The impetus for this combination of bowel opacification and image processing is the observation that the perceived discomfort and embarrassment associated with traditional bowel cleansing is a compliance barrier to colon cancer screening. To address this compliance barrier, the replacement of traditional bowel cleansing with the ingestion of positive contrast material, referred to as fecal tagging, helps distinguish mucosal disease from feces. By subsequently removing the distracting and obscuring opacified bowel contents from the images, the additional subtraction step may facilitate two-dimensional evaluation and preserve the radiologist's ability to evaluate the colon with three-dimensional endoluminal rendering, which is a useful step for assessing indeterminate mucosal features. However, subtraction of the opacified contents can result in unwanted artifacts that detract from the diagnostic quality of the modified images. Specifically, subtraction of opacified bowel contents can result in abrupt unnatural transitions of attenuation in the modified images. These edge artifacts are particularly noticeable at mucosal-air interfaces. A smooth transitional layer is important to the radiologist's perception of normal mucosa. Replacement of this transitional layer with an abrupt change in pixel values results in visually distracting unnatural edges on the three-dimensional images, which limit the radiologist's ability to evaluate the bowel.

### SUMMARY OF THE INVENTION

Exemplary embodiments of the invention as described herein generally include methods and systems for identifying and removing virtual objects in a digitized image for visualizing the image. Methods according to embodiments of the invention herein described are general and suited to a broad range of applications where objects or material need to be removed or delineated, including objects that have been tagged by, for example, contrast enhancement agents. These applications include man-made objects as well as for natural, and in particular, anatomical structures. One example of the application of a method according to an embodiment of the invention is for virtual colonoscopy. In this application, residual stool and liquid in a patient's colon is identified and it appears with a high intensity in the imaged data. This high intensity material hinders the physician's view of the colon wall, which is important doe the detection of colon polyps. Another application of a method according to an embodiment of then invention is the computer-aided detection of colonic polyps in the presence of obscuring material. The obscuring material is virtually removed, after which detection algorithms are applied to automatically detect polyps.

According to an aspect of the invention, there is provided a method for removing a virtual object from a digitized image, including providing a digitized image comprising a plurality of intensities corresponding to a domain of points on a n-dimensional grid, computing a point spread function of the intensities of said image, wherein said point spread function is a measure of the blurriness of said image, marking a plurality of points that represent an object of interest in said image, and subtracting the point spread function value from the intensity for each marked point, wherein said object of interest is removed from said image.

According to a further aspect of the invention, the points in said object of interest are tagged to increase the contrast of said object of interest with respect to said image.

According to a further aspect of the invention, the object of interest is tagged by application of a contrast-enhancing agent to said object of interest prior to the acquisition of said image.

According to a further aspect of the invention, the method comprises volume rendering said image.

According to a further aspect of the invention, marking a virtual object of interest comprises selecting those points in said image domain whose intensity values exceed a predetermined threshold.

According to a further aspect of the invention, the point spread function comprises a plurality of Gaussian functions centered at each point in said image and whose peak value is 1.0.

According to a further aspect of the invention, the method comprises applying the point spread function to the points in the object of interest prior to subtracting said point spread function PSF according to PSF % I, wherein I represents the intensity of each image domain point.

According to a further aspect of the invention, the method comprises determining a maximum point spread function value for each point, and subtracting said maximum point spread function value from the intensity for each marked point.

According to a further aspect of the invention, the method comprises creating a fuzzy map for said object of interest from said point spread function, wherein said fuzzy map value for each point characterizes the degree to which said point is a member of said object of interest.

According to a further aspect of the invention, the values of said fuzzy map range from 0.0 to 1.0, wherein a map value of 0.0 indicates that the point does not belong to said object of interest, while a map value of 1.0 indicates that said point completely belongs to said object of interest.

According to a further aspect of the invention, removing an object of interest from said image comprises subtracting a proportion of an intensity value of a point ion said object of interest that corresponds to said fuzzy map value of said point.

According to a further aspect of the invention, the method comprises inverting said image intensities prior to marking said virtual object of interest.

According to a further aspect of the invention, marking a virtual object of interest comprises selecting those points in said image domain based on their similarly to objects acquired through a different imaging modality.

According to another aspect of the invention, there is provided a program storage device readable by a computer, tangibly embodying a program of instructions executable by the computer to perform the method steps for removing a virtual object from a digitized image.

### BRIEF DESCRIPTION OF THE DRAWINGS

FIG. 1 is a flow chart of a method for de-tagging and removing virtual objects in a digitized image, according to an embodiment of the invention.

FIG. 2 depicts an exemplary, non-limiting 2-dimensional Gaussian point spread function, according to an embodiment of the invention.

FIG. 3 is a block diagram of an exemplary computer system for implementing a method for de-tagging and removing virtual objects according to an embodiment of the invention.

### DETAILED DESCRIPTION OF THE PREFERRED EMBODIMENTS

Exemplary embodiments of the invention as described herein generally include systems and methods for de-tagging and removing virtual objects in a digitized image for computer aided detection and diagnosis. However, specific structural and functional details disclosed herein are merely representative for purposes of describing example embodiments of the present invention. This invention may, however, be embodied in many alternate forms and should not be construed as limited to the embodiments set forth herein.

Accordingly, while the invention is susceptible to various modifications and alternative forms, specific embodiments thereof are shown by way of example in the drawings and will herein be described in detail. It should be understood, however, Is that there is no intent to limit the invention to the particular forms disclosed, but on the contrary, the invention is to cover all modifications, equivalents, and alternatives falling within the spirit and scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between”, “adjacent” versus “directly adjacent”, etc.).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”, “comprising”, “includes” and/or “including”, when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved.

As used herein, the term “image” refers to multi-dimensional data composed of discrete image elements (e.g., pixels for 2-D images and voxels for 3-D images). The image may be, for example, a medical image of a subject collected by computer tomography, magnetic resonance imaging, ultrasound, or any other medical imaging system known to one of skill in the art. The image may also be provided from non-medical contexts, such as, for example, remote sensing systems, electron microscopy, etc. Although an image can be thought of as a function from R³ to R, the methods of the inventions are not limited to such images, and can be applied to images of any dimension, e.g. a 2-D picture or a 3-D volume. For a 2- or 3-dimensional image, the domain of the image is typically a 2- or 3-dimensional rectangular array, wherein each pixel or voxel can be addressed with reference to a set of 2 or 3 mutually orthogonal axes. The terms “digital” and “digitized” as used herein will refer to images or volumes, as appropriate, in a digital or digitized format acquired via a digital acquisition system or via conversion from an analog image.

Furthermore, as used herein, the term de-tagging simply refers to a general technique according to an embodiment of the invention for removing any virtual object, referred to as a tagged object, and does not specifically mean removal of data that has been tagged by a contrast enhancing agent.

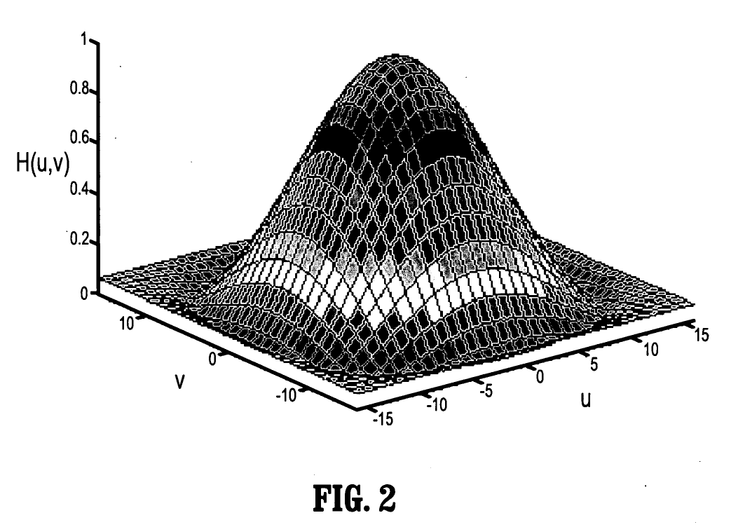

Most imaging systems, such as CT or MRI systems, are not perfect optical systems. As a result, the signals processed by these systems undergo a certain degree of degradation. A simple example is projecting a small dot of light, a point, through a lens. The image of this point will not be the same as the original, as the lens will introduce a small amount of blur. If a lens had perfect optics the image of this point would be identical to the original point of light. However, lenses are not perfect so the relative intensity of the point of light is distributed across the image as shown by curved surface depicted in FIG. 2. This surface is a 2-dimensional representation of a “point spread function” (PSF), and represents intensity as a function of x- and y-image grid coordinates. An exemplary, non-limiting PSF is essentially a Gaussian, as depicted in FIG. 2.

Most blurring processes can be approximated by convolution integrals with respect to the PSF. For discrete image processing, the convolution integral is replaced by a sum. The blurry image J(n,m) can be obtained from the original image I(n,m) by this convolution:

$$J ( n , m ) = {\sum }_{i = - ∞}^{+ ∞} {\sum }_{j = - ∞}^{+ ∞} I ( n + 1 , m + j ) h ( - i , - j ) ,$$

where the function h(n,m) is the discrete PSF for the imaging system. Also of interest is the Discrete Fourier Transform (DFT) representation of the point-spread function, given by

$$H ( u , v ) = {\sum }_{n = 0}^{N - 1} {\sum }_{m = 0}^{M - 1} h ( n , m ) exp ( - 2 π i ( \frac{un}{N} + \frac{vm}{M} ) ) .$$

H(u,v) defines a set of coefficients for plane waves of various frequencies and orientations, called spatial frequency components, that reconstruct the PSF exactly when multiplied by the coefficients H(u,v) and summed. The function H(u,v) is referred to as the transfer function, or system frequency response. By examining |H(u,v)|, one can quickly determine which spatial frequency components are passed or attenuated by the imaging system.

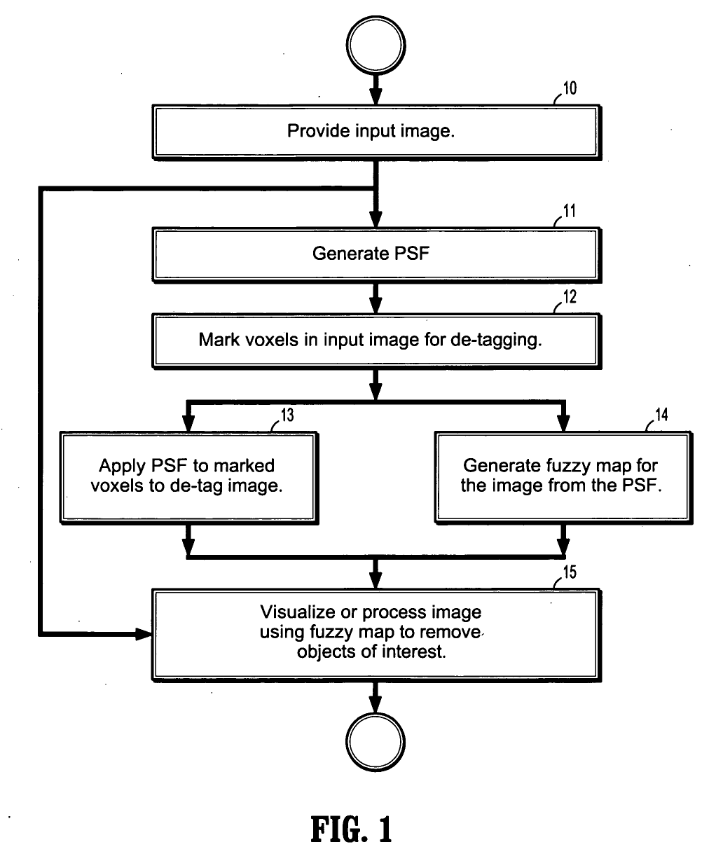

FIG. 1 is a block diagram of a virtual object removal method according to an embodiment of the invention. The input volume provided at step 10 is the input 3D volumetric dataset. Every imaged dataset can be characterized by an implicit point spread function (PSF). According to an embodiment of the invention, a generic Gaussian PSF is defined at step 11 to the input dataset for voxel identification and removal. This generic PSF is formulated so that the value at the peak of the Gaussian is 1.0. One exemplary method of applying the generic PSF to a whole dataset is to represent the dataset as a superposition of PSFs, where each PSF is centered on a grid point of the image.

This dataset 10 is processed in step 12 to mark the object of interest, which identifies voxels for removing. This marking can be performed by a variety of techniques, as are well known in the art. One technique involves utilizing user interaction to mark the object of interest. A technique according to another embodiment of the invention performs an appropriate automatic or semi-automatic segmentation.

According to an embodiment of the invention where voxels have been tagged, voxels to be removed can be identified by thresholding, since tagging increases the intensity of the voxels in the images data. A conservative threshold is used to detect and mark only the high intensity voxels in the dataset. An empirically determined threshold is used along with neighborhood information to determine whether or not a voxel should be detagged. In partial volume regions, the intensity by itself is not enough, and the neighborhood of a given voxel is checked to see if it is a partial volume area. Here, partial volume refers to the region between 2 objects that do not include representative intensities of either of the 2 objects. The intensity is usually in between that of the 2 neighboring object intensities. If a voxel is in a partial volume, then the average intensity of tagged voxels in the neighborhood is used as the determination criterion. The marked voxels include all properly tagged voxels, but do not include voxels that are part of the partial volume, as those voxels have a lower intensity.

When the virtual object of interest that has to be identified and removed has lower intensity than the objects surrounding it (i.e., the case is opposite to tagging), the intensity of the entire image can be inverted, where the original low intensity object will now be a high intensity object and the surrounding material will now have low intensity.

According to an embodiment of the invention, the PSF is applied at step 13 to each voxel so marked. A new PSF is defined for each voxel (i,j,k) to be removed according to
PSF_{new}(i,j,k)=PSF(i,j,k) % I(ij,k),
where I is the image intensity at the central voxel (i,j,k) that is to be removed. The goal is to subtract the PSF_{new} from the dataset, however, since the PSF for each voxel covers multiple voxels, subtraction for each of them can lead to negative values. To avoid the negative values, the subtraction amount for each voxel as given by the PSF is saved. Since multiple PSFs can be applied to each voxel, only the maximum PSF subtraction value need be saved. Once the PSF has been applied to all voxels that are to be removed, the PSF subtraction values are saved for each of the voxels in the dataset. The subtraction values are then subtracted from the original pixel values to produce the de-tagged dataset. If it is desired that the original dataset be preserved, the saved subtraction values are stored, and the subtraction is performed per-pixel as needed.

According to another embodiment of the invention, a fuzzy object map is created at step 14 from the PSF for the object of interest. This map defines the amount of the object that is contained in each voxel of the input volume. This map has a one-to-one correspondence with the voxels of the original input volume. An exemplary fuzzy map is created using the PSF by applying the PSF for all the voxels that need detagging. A map value of 1.0 indicates that the corresponding voxel in the input volume completely belongs to the object, whereas a map value of 0.0 indicates that the corresponding voxel in the input volume does not belong to the object at all. Values between 0.0 and 1.0 indicate that the voxel partially belongs to the object, and the actual value is indicative of the degree to which a voxel belongs to the object. These fuzzy map values thus also determine the degree to which an object voxel is removed or ignored during visualizations.

The input volume and fuzzy object map is then used at step 15 for visualization and computer aided detection and diagnosis. For example, a voxel whose fuzzy map value is 1.0 completely belongs to the object to be removed, and thus this voxel is completely ignored during a visualization procedure, such as volume rendering. On the other hand, a voxel whose fuzzy map value is 0.0 does not belong to the object to be ignores, and its value will be included in the visualization procedure. However, a voxel whose fuzzy map value p is between 0 and 1 will be partially included in the visualization procedure, according to the ratio p of the voxel's intensity.

One application of an embodiment of the invention is using data from one imaging modality to remove or mask objects or artifacts that appear in an image acquired through another imaging modality. For example, a CT image can be corrected based on a corresponding PET image. One can remove or mask out certain objects in a CT image that have intensities similar to certain other objects with known PET characteristics. By removing or masking out these objects in the CT image, a PET correction can be applied only to those objects with known PET characteristics.

It is to be understood that various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

Furthermore, it is to be understood that the present invention can be implemented in various forms of hardware, software, firmware, special purpose processes, or a combination thereof. In one embodiment, the present invention can be implemented in software as an application program tangible embodied on a computer readable program storage device. The application program can be uploaded to, and executed by, a machine comprising any suitable architecture.

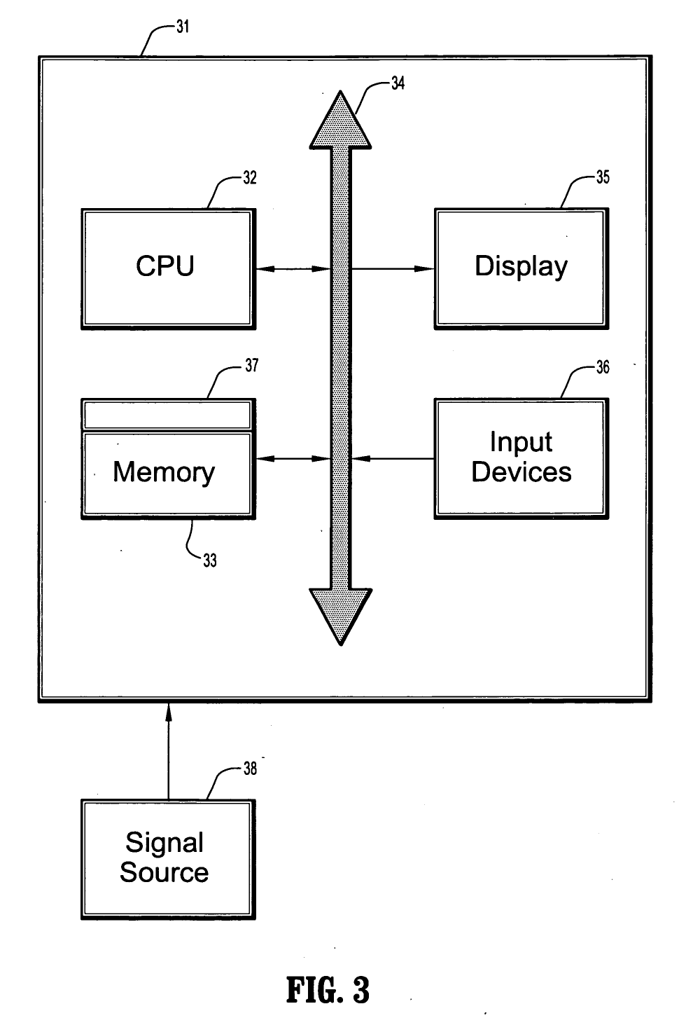

Accordingly, FIG. 3 is a block diagram of an exemplary computer system for implementing a method for de-tagging and removing virtual objects according to an embodiment of the invention. Referring now to FIG. 3, a computer system 31 for implementing the present invention can comprise, inter alia, a central processing unit (CPU) 32, a memory 33 and an input/output (I/O) interface 34. The computer system 31 is generally coupled through the I/O interface 34 to a display 35 and various input devices 36 such as a mouse and a keyboard. The support circuits can include circuits such as cache, power supplies, clock circuits, and a communication bus. The memory 33 can include random access memory (RAM), read only memory (ROM), disk drive, tape drive, etc., or a combinations thereof. The present invention can be implemented as a routine 37 that is stored in memory 33 and executed by the CPU 32 to process the signal from the signal source 38. As such, the computer system 31 is a general purpose computer system that becomes a specific purpose computer system when executing the routine 37 of the present invention.

The computer system 31 also includes an operating system and micro instruction code. The various processes and functions described herein can either be part of the micro instruction code or part of the application program (or combination thereof) which is executed via the operating system. In addition, various other peripheral devices can be connected to the computer platform such as an additional data storage device and a printing device.

It is to be further understood that, because some of the constituent system components and method steps depicted in the accompanying figures can be implemented in software, the actual connections between the systems components (or the process steps) may differ depending upon the manner in which the present invention is programmed. Given the teachings of the present invention provided herein, one of ordinary skill in the related art will be able to contemplate these and similar implementations or configurations of the present invention.

While the present invention has been described in detail with reference to a preferred embodiment, those skilled in the art will appreciate that various modifications and substitutions can be made thereto without departing from the spirit and scope of the invention as set forth in the appended claims.

What is claimed is:

1. A method for identifying and removing a virtual object from a digitized image comprising the steps of:
providing a digitized image comprising a plurality of intensities corresponding to a domain of points on a n-dimensional grid;
computing a point spread function of the intensities of said image, wherein said point spread function is a measure of the blurriness of said image;
marking a plurality of points that represent an object of interest in said image; and
subtracting the point spread function value from the intensity for each marked point, wherein said object of interest is removed from said image.

2. The method of claim 1, wherein the points in said object of interest are tagged to increase the contrast of said object of interest with respect to said image.

3. The method of claim 2, wherein said object of interest is tagged by application of a contrast-enhancing agent to said object of interest prior to the acquisition of said image.

4. The method of claim 1, further comprising volume rendering said image.

5. The method of claim 1, wherein marking a virtual object of interest comprises selecting those points in said image domain whose intensity values exceed a predetermined threshold.

6. The method of claim 1, wherein said point spread function comprises a plurality of Gaussian functions centered at each point in said image and whose peak value is 1.0.

7. The method of claim 6, further comprising applying the point spread function to the points in the object of interest prior to subtracting said point spread function PSF according to PSF % I, wherein I represents the intensity of each image domain point.

8. The method of claim 7, further comprising determining a maximum point spread function value for each point, and subtracting said maximum point spread function value from the intensity for each marked point.

9. The method of claim 1, further comprising creating a fuzzy map for said object of interest from said point spread function, wherein said fuzzy map value for each point characterizes the degree to which said point is a member of said object of interest.

10. The method of claim 9, wherein the values of said fuzzy map range from 0.0 to 1.0, wherein a map value of 0.0 indicates that the point does not belong to said object of interest, while a map value of 1.0 indicates that said point completely belongs to said object of interest.

11. The method of claim 10, wherein removing an object of interest from said image comprises subtracting a proportion of an intensity value of a point ion said object of interest that corresponds to said fuzzy map value of said point.

12. The method of claim 5, further comprising inverting said image intensities prior to marking said virtual object of interest.

13. The method of claim 1, wherein marking a virtual object of interest comprises selecting those points in said image domain based on their similarly to objects acquired through a different imaging modality.

14. A method for identifying a virtual object from a digitized image comprising the steps of:
providing a digitized image comprising a plurality of intensities corresponding to a domain of points on a n-dimensional grid; and
marking a plurality of points that represent an object of interest in said image;
creating a fuzzy map for said object of interest, wherein said fuzzy map value for each point characterizes the degree to which said point is a member of said object of interest wherein the values of said fuzzy map range from 0.0 to 1.0, wherein a map value of 0.0 indicates that the point does not belong to said object of interest, while a map value of 1.0 indicates that said point completely belongs to said object of interest.

15. The method of claim 14, further comprising computing a point spread function of the intensities of said image, wherein said point spread function is a measure of the blurriness of said image, and using said point spread function to compute said fuzzy map.

16. The method of claim 14, further comprising visualizing said image based on said fuzzy mask.

17. The method of claim 16, wherein visualizing said image comprises volume rendering said image, wherein said volume rendering comprises subtracting a proportion of an intensity value of a point in said object of interest that corresponds to said fuzzy map value of said point representing said object of interest prior to accumulating said point value during said rendering.

18. A program storage device readable by a computer, tangibly embodying a program of instructions executable by the computer to perform the method steps for removing a virtual object from a digitized image, said method comprising the steps of:
providing a digitized image comprising a plurality of intensities corresponding to a domain of points on a n-dimensional grid;
computing a point spread function of the intensities of said image, wherein said point spread function is a measure of the blurriness of said image;
marking a plurality of points that represent an object of interest in said image; and
subtracting the point spread function value from the intensity for each marked point, wherein said object of interest is removed from said image.

19. The computer readable program storage device of claim 18, wherein the points in said object of interest are tagged to increase the contrast of said object of interest with respect to said image.

20. The computer readable program storage device of claim 19, wherein said object of interest is tagged by application of a contrast-enhancing agent to said object of interest prior to the acquisition of said image.

21. The computer readable program storage device of claim 18, the method further comprising volume rendering said image.

22. The computer readable program storage device of claim 18, wherein marking a virtual object of interest comprises selecting those points in said image domain whose intensity values exceed a predetermined threshold.

23. The computer readable program storage device of claim 18, wherein said point spread function comprises a plurality of Gaussian functions centered at each point in said image and whose peak value is 1.0.

24. The computer readable program storage device of claim 23, the method further comprising applying the point spread function to the points in the object of interest prior to subtracting said point spread function PSF according to PSF % I, wherein I represents the intensity of each image domain point.

25. The computer readable program storage device of claim 24, the method further comprising determining a maximum point spread function value for each point, and subtracting said maximum point spread function value from the intensity for each marked point.

26. The computer readable program storage device of claim 18, the method further comprising creating a fuzzy map for said object of interest from said point spread function, wherein said fuzzy map value for each point characterizes the degree to which said point is a member of said object of interest.

27. The computer readable program storage device of claim 26, wherein the values of said fuzzy map range from 0.0 to 1.0, wherein a map value of 0.0 indicates that the point does not belong to said object of interest, while a map value of 1.0 indicates that said point completely belongs to said object of interest.

28. The computer readable program storage device of claim 27, wherein removing an object of interest from said image comprises subtracting a proportion of an intensity value of a point ion said object of interest that corresponds to said fuzzy map value of said point.

29. The computer readable program storage device of claim 22, further comprising inverting said image intensities prior to marking said virtual object of interest.

30. The computer readable program storage device of claim 18, wherein marking a virtual object of interest comprises selecting those points in said image domain based on their similarly to objects acquired through a different imaging modality.
